(19) United States
(12) Patent Application Publication
(10) Pub. No.: US 2026/0228325 A1
(43) Pub. Date: Aug. 6, 2026

(54) SYSTEMS AND METHODS FOR MANAGING WORKLOAD OF DATA SOURCES USING A DATA TRANSFER TIME WINDOW

(71) Applicant: Dell Products L.P., Round Rock, TX (US)

(72) Inventors: SRIKRISHNA CHAITANYA GARIMELLA, Bengaluru (IN); VIVEKANANDH NARAYANASAMY RAJAGOPALAN, Bangalore (IN)

(21) Appl. No.: 19/043,737

(22) Filed: Feb. 3, 2025

(51) Int. Cl. G06F 21/45; G06F 9/50

(52) U.S. Cl. CPC G06F 21/45; G06F 9/5055

(57) ABSTRACT

Methods and systems for managing operation of a data processing system are disclosed. To manage operation of the data processing system, a policy update specifying a change in operation of data processing system may be obtained. Based at least in part on the policy update and/or a period of time in which a data processing system is to obtain data from a data source used to perform the policy update, a data processing system impacted by the policy update may identify a point in time to attempt to obtain the data from the data source. By doing so, updating operation of the data processing system using the data to complete the policy update may be appropriately performed in a method to allow sufficient capacity of the data source to provide the copies of the data to each data processing systems impacted by the policy update during the period of time.

### FIELD

Embodiments disclosed herein relate generally to providing customized services to users of data processing systems. More particularly, embodiments disclosed herein relate to systems and methods to managing operation of a deployment comprising data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating data flows in accordance with an embodiment.

FIG. 2B shows an interaction diagram in accordance with an embodiment.

FIG. 3 shows a flow diagram illustrating a method for managing operation of a deployment comprising data processing systems in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment. The deployment may include any number of data processing systems (e.g., computing devices, data centers, etc.) with in-band components (e.g., various hardware components and/or software resources). The in-band components may perform various processes including startup processes, software installation processes, and/or other types of processes. The data processing systems may provide computer-implemented services to any type and number of other devices and/or users of the data processing systems. The computer-implemented services may include any quantity and type of such services.

To provide the computer-implemented services, the data processing systems may need to operate in a manner conducive to, for example, security policies (e.g., established by an administrator of the data processing systems) that provide encryption standards, data protection requirements, access controls, etc. For example, an administrator of the data processing systems may establish security rules such as password policies, firewall settings, etc. in order to secure the integrity of the data processing systems (and/or sensitive data accessible or managed by the data processing systems). Although referencing operation of the data processing systems in compliance with security policies, any type of policies (e.g., access policies, resource management policies, etc.) may apply.

Over time, a type and/or quantity of the computer-implemented services desired by a user and/or administrator of the data processing systems may change. For example, updates to user policies may be implemented to restrict and/or limit user actions such as limiting access to certain applications, websites, and/or any sensitive data accessible via operation of the data processing systems by users. To update operation of the data processing systems and, therefore, to provide updated computer-implemented services, a management agent may be hosted by the hardware resources of the respective data processing system. The management agent may include a program responsible for facilitating management of policy updates and/or data transfers for the data processing system (e.g., via operation of the hardware resources and/or software resources of the respective data processing system).

To facilitate policy management services, the management agent may request, transmit, collect, and/or manage data (e.g., usable to perform the respective policy update) from a data source (e.g., server, another data processing system, etc.). For example, a server (e.g., the data source) may store, transmit (e.g., to data processing systems), and/or otherwise manage the data necessary to perform a security policy update for a data processing system. The data source may include a finite quantity of computing resources (e.g., hardware resources and/or software resources) in order to cooperatively provide the computer-implemented services. The finite quantity of computing resources may limit the quantity and types of computer-implemented services that may be provided at any point in time (e.g., limited collection, transmission, and/or management of the data). For example, if multiple data processing systems attempt to retrieve data or apply policy updates from a single server (e.g., hosting the data necessary to perform the policy updates) at the same time, the server's finite capacity for processing and/or transferring the data may be overwhelmed (e.g., due to bandwidth limitations, high load, etc.). Consequently, when the finite resources of the data source are strained, slow down in transfer speeds, failed transfer, increased system errors, and/or system failures may occur.

As a result, data that may include relevant information necessary to perform the policy updates may not be transmitted to and/or obtained by the management agents of the data processing systems in order to update operations of the data processing systems and provide the desired computer-implemented services (e.g., for the users of the data processing systems).

To manage the consumption of the limited resources (of a data source) by concurrent demand from multiple data processing systems, a workload management framework that selectively identifies a dynamic transfer window (e.g., a period of time) for data transfers and a staggered initiation of data transfers by the data processing systems within the dynamic transfer window may be implemented. The workload management framework may provide tailored scheduling of data transfers to limit the amount of data being processed and/or transmitted from a data source to data processing systems based on the total workload and available capacity of the data source.

By doing so, fewer computing resources may be expended (e.g., in a similar and/or the same time period) for processing and/or transmitting data usable to perform policy updates. As such, the efficiency of the limited computing resources usable to process and/or transmit the data usable to perform the policy updates may be increased and the reliability of policy updates and data transfers may be enhanced. Therefore, the likelihood of obtaining the data usable to perform the policy updates may be increased, and thereby, increasing the likelihood of updating operation of the data processing systems using the data to complete the policy update in order to facilitate continued provisioning of desired computer-implemented services.

In an embodiment, a method for managing operation of a data processing system is disclosed. The method may include: obtaining, by a data processing system of the data processing systems, a policy update and a window definition; identifying, by the data processing system, a data source that has data usable to perform the policy update; identifying, by the data processing system, a point in time to attempt to obtain the data from the data source, the point in time being based on the window definition and a distribution function used by all of the data processing systems to distribute load on the data source and from the data processing systems across time; and attempting, by the data processing system, to obtain the data from the data source and at the point in time; in a first instance of the attempting where the data is successfully obtained: updating operation of the data processing system using the data to complete the policy update to facilitate continued provisioning of computer implemented services.

The window definition may define a period of time in which the data processing system is to obtain the data from the data source.

The distribution function may be adapted to select the point in time within the period of time.

The distribution function may randomly select the point in time from any points in time during the period of time, and each of the data processing systems using same distribution functions.

The policy update may specify a change in operation of the data processing system that requires use of the data.

The data source may be remote to the data processing system, and the data source may be adapted to provide copies of the data to each of the data processing systems.

The policy update may be obtained from a management system that issues the policy updates to a portion of the data processing systems, and the data source may lack sufficient capacity to provide the copies of the data to each data processing system of the portion of the data processing systems at a same point in time.

The data source may have sufficient capacity to provide the copies of the data to each data processing system of the portion of the data processing systems during a period of time defined by the window definition.

The policy update may be completed after the operation of the data processing system has been updated using the data.

The updated operation of the data processing system may reduce at least one selected from a group consisting of: risk of compromise of the data processing system; undesired operation of the data processing system; and risk of loss of data hosted by the data processing system.

The window definition may be based on a capacity of the data source for providing copies of the data and a total number of the data processing systems to which the policy update may be applied.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

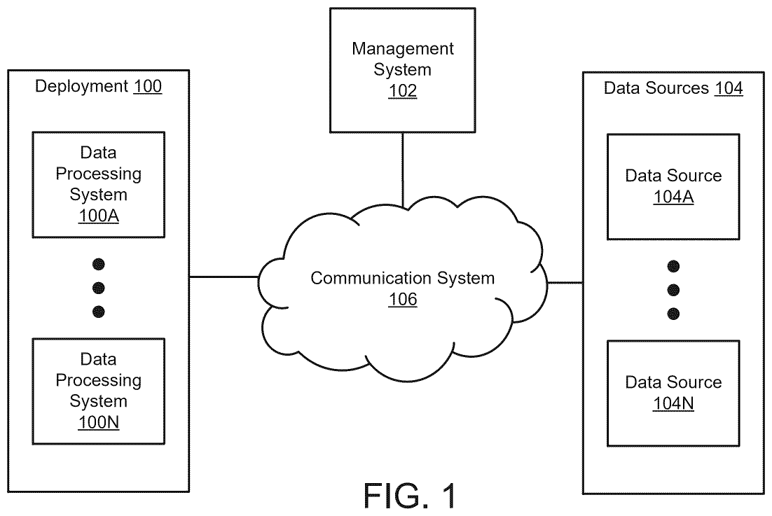

Turning to FIG. 1, a block diagram illustrating a system in accordance with an embodiment is shown. The system shown in FIG. 1 may provide, at least in part, computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided by, for example, deployment 100, management system 102, data sources 104, and/or any other type of devices (not shown in FIG. 1). Other types of computer-implemented services may be provided by the system shown in FIG. 1 without departing from embodiments disclosed herein.

To provide the computer-implemented services, deployment 100 may include any number of data processing systems (e.g., data processing system 100A—data processing system 100N). Each of the data processing systems (e.g., 100A-100N) may include any number of hardware components (e.g., processors, memory modules, storage devices, communication devices, etc.) and/or software components (e.g., operating system, device drivers, application programs, etc.) which may be used, at least in part, to provide the computer-implemented services. For example, deployment 100 may be a data center including various components such as, servers, routers, storage systems, security systems, etc. that host operating systems, applications, etc. that perform different processes in order to provide computer-implemented services. Changes in available functionalities of the hardware and/or software components of the data processing systems may provide for various types of different computer-implemented services to be provided over time.

Over time, the type and/or quantity of the computer-implemented services desired by a user and/or administrator of the data processing systems (e.g., 100A-100N) may change (e.g., due to security policies, user access policies, and/or any other type of policies). To accommodate modification to the provided computer-implemented services, operation of the hardware resources and/or software components hosted by the hardware resources may be modified.

To update operation of the data processing systems, and therefore, to provide updated computer-implemented services, a management agent may be hosted by the hardware resources of each data processing system. The management agent may include a program responsible for managing policy updates including requesting, collecting, and/or otherwise managing data usable to perform the policy updates.

To cooperatively provide the computer-implemented services, data sources 104 may include any number of data sources (e.g., data source 104A—data source 104N). Each of the data sources may provide any type and/or quantity of data usable to manage operation of any of the data processing systems in deployment 100. For example, the data may include a policy rollout (e.g., specific configurations, rules, and/or updates) to deploy across any number of data processing systems (e.g., of deployment 100) in order to manage operation of the data processing systems (e.g., how the systems, applications, and/or users of the data processing systems are configured and/or operate).

The policy update may be performed instantaneously (e.g., upon receipt of the policy update) and/or on a scheduled basis for certain data processing systems in deployment 100. For example, the policy update may be initiated at the time the policy has been defined, established (e.g., by an administrator, subject matter expert, etc.), and/or provided to the data processing systems. Conversely, the policy update for the data processing systems may be scheduled to run at a specific time (e.g., on Wednesday at midnight).

To provide the data for the policy update, data sources 104 may have hardware components and/or software resources hosted by the hardware components that provide the capabilities to process and/or transmit the data to one or more data processing systems (e.g., 100A-100N). However, providing the data to one or more data processing systems by a data source within a specific time frame may consume limited computing resources of the data source. For example, based on the load (e.g., amount to work being performed and/or demand placed on the limited resources at a given time) necessary for the data transfer, usage of the hardware resources and/or software components of the data source (e.g., 104A) may differ and the data source may not have enough computing resources (e.g., processing resources, network resources, and/or any other computing resources) to process and/or transmit the data (e.g., usable for performing the policy update) to the data processing systems.

For example, a policy update may require twenty-five laptops to each download a one gigabyte (GB) file from a single file server within a specific time frame. All twenty-five laptops may attempt to access the file server simultaneously to retrieve the 1 GB file, thereby increasing bandwidth usage at a point in time and overloading the bandwidth, thereby resulting in severe slowdowns (e.g., slow down in transfer speeds).

Consequently, the limited capability and/or reduced functionality of the data source may lead to inability to provide the data to the data processing systems before the end of a pre-established time (e.g., a system timeout). For example, data processing system 100A may fail to download the data from data source 104A within a designated timeframe, and therefore, data processing system 100A may erroneously identify the data transfer as a failure.

In general, embodiments disclosed herein may provide methods, systems, and/or devices for managing operation of a deployment of data processing systems by implementing a dynamic workload management system that leverages monitoring operational load of a data source and the total workload (to perform data transfers for a policy update) to schedule initiation of the policy update by the data processing systems over a period of time. To do so, a dynamic transfer window (e.g., time window) for data transfers based on, at least in part, the data source's load and the number of data processing systems involved in the data transfer may be identified.

The dynamic transfer window may be used to provide a point in time for each data processing system to initiate transfer of data from the data source over a period of time. Therefore, as the load (e.g., on the data source) changes (e.g., more and/or less bandwidth becomes available), the time window for data transfers may be adjusted dynamically. By doing so, a dynamic method for managing concurrent workloads by leveraging operational load monitoring and staggered scheduling may be provided. Thereby increasing the likelihood that the limited computing resources may be efficiently utilized while reducing system errors and/or overloads and enhancing the reliability of data transfers usable to perform policy updates in order to facilitate continued provisioning of computer-implemented services by the data processing systems.

To provide the above noted functionality, the system of FIG. 1 may include deployment 100, management system 102, data sources 104, and communication system 106. Each of these components is discussed below.

Deployment 100 may provide computer-implemented services (e.g., to users of deployment 100 and/or to devices operably connected to deployment 100). To do so, deployment may include any number of data processing systems (e.g., 100A-100N) that may be used by businesses, individuals, and/or other users. Each of the data processing systems (e.g., 100A-100N) may include any number of hardware and/or software components configured to provide the computer-implemented services. When providing the computer-implemented services, for example, data processing system 100A (and/or any of data processing systems of deployment 100) may identify issues negatively impacting operation of data processing system 100A and may communicate information regarding the issues to external devices tasked with managing operation of data processing system 100A.

To perform their functionality, data processing system 100A may: (i) monitor operation of the hardware components and/or software resources (e.g., hosted by the data processing system), (ii) obtain a policy update and a window definition (e.g., dynamic transfer window), (iii) identify a data source that has data usable to perform the policy update, (iv) identify a point in time to attempt to obtain the data from the data source, (v) attempt to obtain the data from the data source (e.g., at the identified point in time), (vi) if the data is successfully obtained, use the data to update operation of the data processing system to complete the policy update, and/or (vii) perform other tasks.

To identify the issue, data processing system 100A may host a management agent (e.g., a software program) and/or may communicate with external entities (e.g., management system 102 and/or other management devices). For example, the monitoring software may monitor operation of data processing system 100A and identify issues impacting operation of data processing system 100A. For example, data processing system 100A (e.g., more specifically the monitoring software) may identify an occurrence of a failure by a storage device (hosted by data processing system 100A) to store data and may communicate the issue to management system 102.

Data sources 104 may include any type and/or number of data sources (e.g., 104A-104N). Each data source of data sources 104 may include hardware and/or software components configured to obtain data, store data, provide data to other entities, and/or to perform any other task to facilitate performance of the computer-implemented services. All, or a portion, of data sources 104 may provide (and/or participate in and/or support the) computer-implemented services to various devices operably connected to data sources 104. Different data sources may provide similar and/or different computer-implemented services.

Data sources 104 may receive notifications from management system 102 (e.g., via a communication system) and may access to data and/or manage data for any of data processing systems 100A-100N. Data sources 104 may be organized so that each data source of data sources 104 is associated with a user of endpoint devices 104, and an data source assigned to a user may be allowed to store, modify, and/or access the data in a data processing system associated with the user. For example, data source 104A and data source 104B may be associated with a first user (e.g., administrator of deployment 100) and data source 104C may be associated with a second user (e.g., another administrator of deployment 100).

To obtain the information regarding policy updates impacting data processing systems by data sources 104, management system 102 may identify a policy update and the mechanism in which information regarding the policy update may be communicated through to the identified data processing system(s) to facilitate data transfers to perform the policy update.

Management system 102 may perform tasks relating to management of and/or facilitation of use of deployment 100 (e.g., any of data processing systems 100A-100N). Management system 102 may include any number and/or type of devices (e.g., other data processing systems, servers, storage devices, user devices) that may be used to manage the data processing systems. As part of managing the data processing systems, management system 102 may train and/or host any number and/or type of machine learning models and/or inference models trained to obtain classifications (e.g., inferences) for different types of issues. The trained machine learning model may include generative artificial intelligence (AI) inference models (e.g., large language models (LLMs)); therefore, the responses may include new instances of data created by the generative AI inference models based on learned associations established during inference model training. For example, the inference models may be trained using unstructured data, such as stories, essays, audio transcription, video description, and/or other types of human interpretable text, to generate responses of the same. The notifications of issues provided to management system 102 by data processing systems 100A-100N may be used as input data for the trained machine learning models managed by management system 102.

To perform its functionality, management system 102 may: (i) obtain notifications and/or any form of communication from data processing systems 100A-100N regarding issues impacting the respective data processing system, (ii) analyze the notifications to identify a type of issue indicated by the notification, (iii) identifying a person tasked with managing the issue impacting the desired computer implemented services being provided by the data processing system (e.g., based on at least the notification and/or the type of issue indicated by the notification), (iv) identify various devices associated with the person (e.g., all the devices registered to the person), (v) select a device from the various devices based on any type of metrics regarding each device (e.g., including response times of the person to notifications sent to the devices, a last used device, a most frequently used device, and/or computing capabilities of the devices), (vi) attempt to notify the person of the issue using the first device (e.g., any of endpoint devices 104) and the device type independent version of the notification, (vii) receiving acknowledgements from the endpoint devices in response to providing the device type independent version of the notification, and/or (viii) perform other tasks.

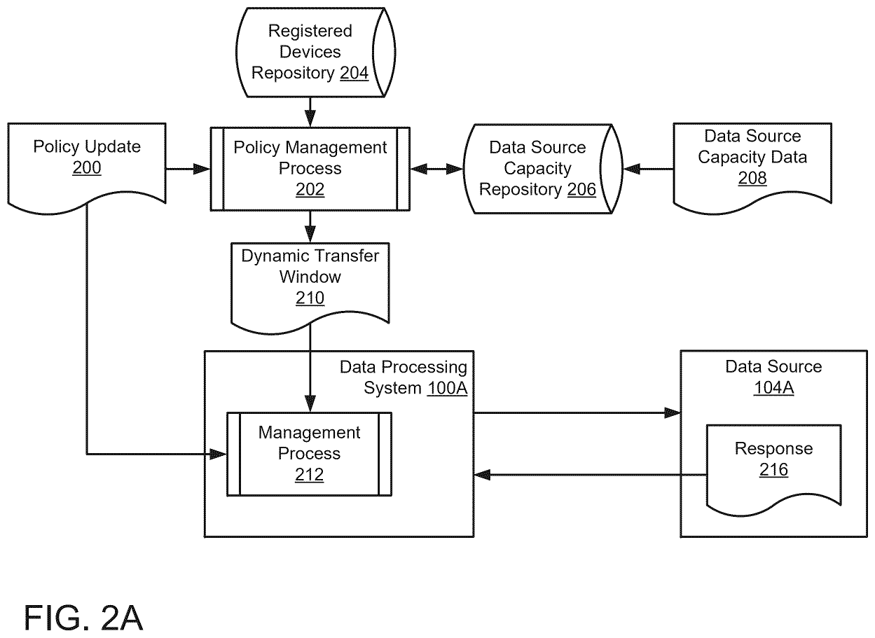

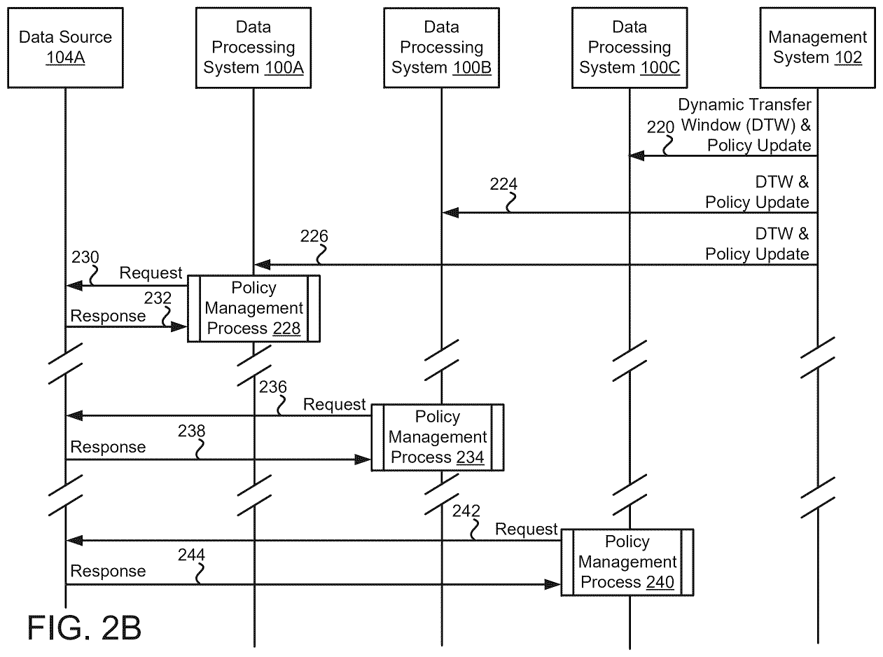

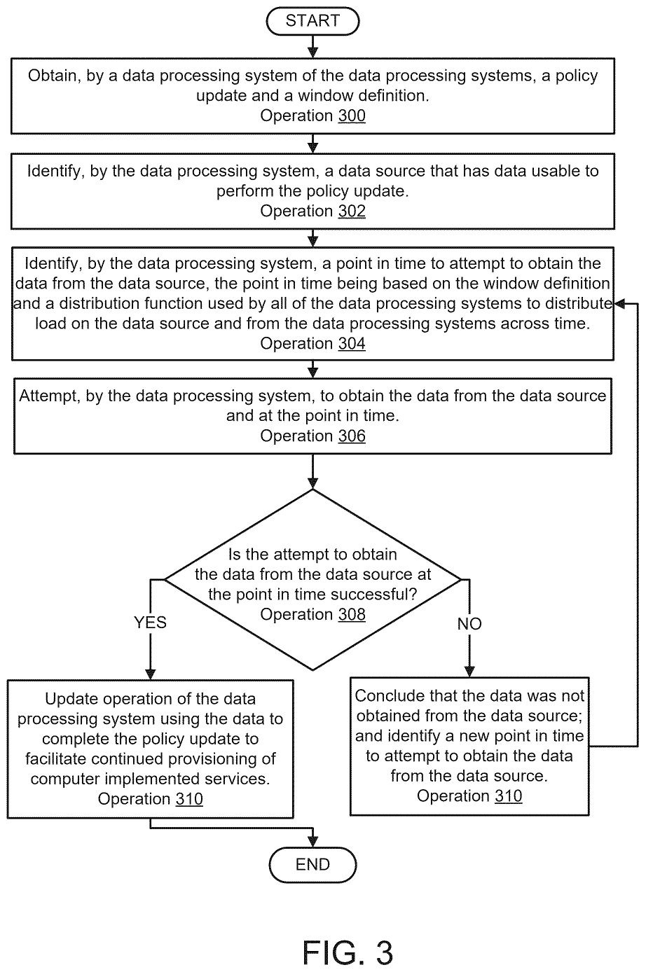

When providing their functionality, any of (and/or components thereof) deployment 100, management system 102, and/or data sources 104 may perform all, or a portion, of the actions and methods illustrated in FIGS. 2A-3.

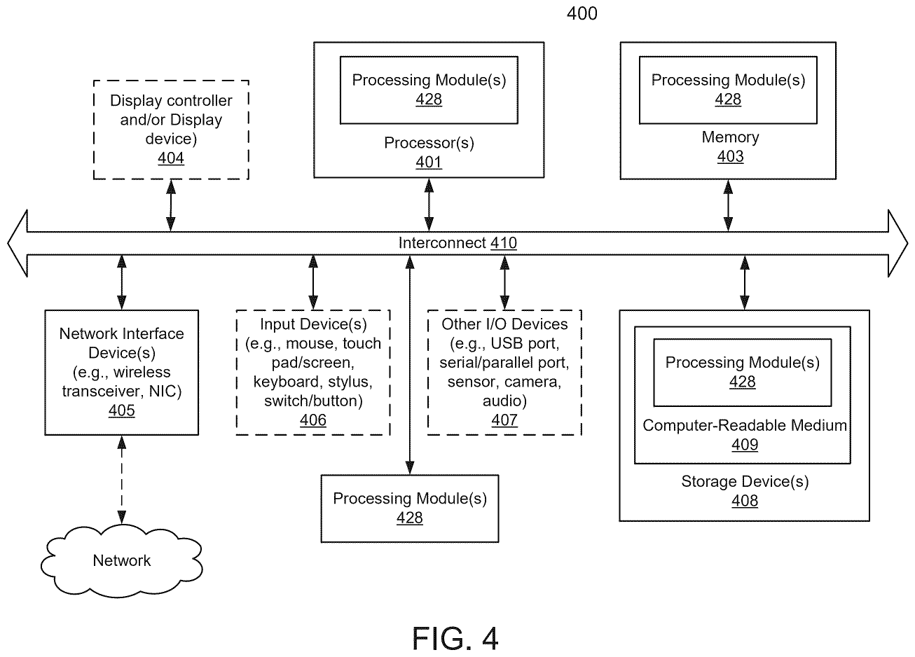

Any of (and/or components thereof) deployment 100, management system 102, and data sources 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, a data flow diagram in accordance with an embodiment are shown in FIG. 2A. In the diagram, flows of data and processing of data are illustrated using different sets of shapes. A first set of shapes (e.g., 200, 208, etc.) is used to represent data structures, a second set of shapes (e.g., 202, 212, etc.) is used to represent processes performed using and/or that generate data, and a third set of shapes (e.g., 204, 206) is used to represent large scale data structures such as databases.

Turning to FIG. 2A, a first data flow diagram in accordance with an embodiment is shown. The data flow diagram may illustrate data used in and data processing performed during management of policy updates (e.g., 200) for data processing systems based on identification of a dynamic transfer window.

To do so, policy update 200 may be obtained. Policy update 200 may be obtained from, for example, user input (e.g., administrator of the data processing systems), based on a system schedule for updating policies for deployment 100 (e.g., any of data processing systems 100A-100N), etc. Policy update 200 may include any type and/or quantity of configurations, rules, and/or updates for managing operation of hardware resources and/or software components of data processing systems. Policy update 200 may include updates for different types of policies such as, security policies (e.g., access controls, encryption, etc.), system management policies (e.g., control device settings, application configurations, etc.), network policies (e.g., bandwidth allocation, connectivity protocols, etc.), and/or any other type of polices.

For example, policy update 200 may specify the rules and/or configurations for a portion of data processing systems (e.g., a class of devices). For example, policy update 200 may specify all laptops must have an updated version of an antivirus software installed.

Policy update 200 may be used during policy management process 202 to identify one or more devices that are subject to the policy update (e.g., 200). During policy management process 202, policy update 200 may be subjected to any type of analysis process to identify a portion of data processing systems (e.g., any of data processing systems 100A-100N) that are affected by the policy update (e.g., impacting the desired computer implemented services being provided by the respective data processing system). The data processing system affected by the policy update (e.g., policy update 200) may be identified from registered devices repository 204.

Registered devices repository 204 may include any type of repository (and/or other storage architecture) storing any quantity of devices associated with various types of updates that may impact operations and/or the desired computer implemented services provided by any of the data processing systems (e.g., data processing systems 100A-100N). For example, registered devices repository 204 may include a database of individual devices associated with various types of policy updates impacting operation of respective data processing systems.

During policy management process 202, policy update 200 may be used to perform any type of comparison process to identify registered devices that are subject to the policy update. For example, a look up process may be performed using the device(s) information as a key in registered devices repository 204 to identify the device(s) in which the policy update is to be applied. Registered devices repository 204 may include information about all devices registered in a system and may be used to identify which devices that may be impacted by a policy update (e.g., policy update 200).

During policy management process 202, a data source (e.g., data source 104A) may be identified using the data specified by the policy update 200. To identify the data source that has data usable to perform policy update 200, policy update 200 may be subjected to any type of analysis process to identify the type of policy update and/or any other information regarding the data usable to perform the policy update. For example, a large language model may be used to identify words and/or phrases included in policy update 200 that are associated with a type of policy update impacting a portion of data processing systems (e.g., data processing systems 100A-100N). For example, policy update 200 may include the text “firmware update for storage system”. Based on the text, the word “storage” and the phrase “firmware update” may be used to identify the type of policy update and/or the data source hosting the data used to perform the corresponding type of policy update.

As part of performing policy management process 202, the capacity of the data source (e.g., providing the data for the policy update) may be identified to obtain dynamic transfer window 210. For example, assessing the current data source's parameters such as, the load on the data source (e.g., server, another data processing system, and/or other data source), may be identified to determine how the policy update may be managed. To do so, data source capacity data 208 for a data source may be obtained.

Data source capacity data 208 may include a communication indicating an issue impacting operation of at least one data processing system. For example, data processing system 100A may host monitoring software which may monitor operation of the hardware components and/or other software resources (e.g., hosted by data processing system 100A) to identify any types of issues (e.g., failures, errors, etc.) limiting, reducing, and/or otherwise negatively impacting performance of data processing system 100A to provide the desired computer implemented services (e.g., to a user of the data processing system).

Data source capacity data 208 may be stored in data source repository 206 for use during policy management process 202. Data source capacity repository 206 may store capacity-related data (e.g., data source capacity data 208) for various data sources (e.g., data sources 104A-104N). For example, data source capacity repository 206 may include current load states of data sources 104A-104N, the number of new workloads being performed by the respective data sources, and/or any other type of information regarding the capacity of a data source.

As a result of performing policy management process 202, dynamic transfer window 210 may be identified. Dynamic transfer window 210 may include a window definition defining a period of time in which a data processing system (e.g., the device impacted by the policy update) is to obtain the data from the identified data source. For example, dynamic transfer window 210 may be calculated based on the existing load on the data source, the number of devices affected by the policy change, the capacity constraints of the data source, and/or any other information. Dynamic transfer window 210 may be used to stager data transfers to limit overloading a data source capacity and increase the likelihood of successful policy application to the portion of devices in which the policy update is to be applied.

Once obtained, dynamic transfer window 210 and policy update 200 may be provided to the respective data processing system (of the data processing systems affected by the policy update). For example, dynamic transfer window 210 and policy update 200 may be provided to data processing system 100A.

Additionally, while described as being provided to a singular data processing system, it will be appreciated that the dynamic transfer window (e.g., 210) and/or the policy update (e.g., 200) may be provided to any of the data processing systems (e.g., data processing systems 100A-100N).

During management process 212, dynamic transfer window 210 and policy update 200 may be used to select a point in time (e.g., within the dynamic transfer window 210) and attempt to obtain the data (e.g., specified by policy update 200) from a data source (e.g., data source 104A) at the selected point in time. To do so, data processing system 100A may generate a data request (e.g., data request 214) to provide to data source 104A as part of performing management process 212. Data request 214 may be provided to data source 104A in a staggered manner (e.g., at different points in time based on the transfer window size) by the data processing systems identified as impacted by policy update 200. For example, each respective data processing system may host a distribution function (e.g., similar to other distribution function of the other data processing systems) to randomly select the point in time from any points in time during the period of time specified by dynamic transfer window 210.

Data source 104A may generate a response (e.g., response 216) to the data request (e.g., data request 214). For example, response 216 may include responses processed from the data source to confirm policy application (e.g., providing the data used to perform the policy update by the respective data processing system). Data source 104A may deliver response 216 6o data processing system 100A that may include the necessary data for policy update 200, while adhering to data requests (e.g., data request 214) received from data processing systems affected by policy update 200 in a staggered manner.

Thus, by implementing the data flows shown in FIG. 2A, a system in accordance with embodiments disclosed herein may have an increased likelihood of providing data usable to perform policy updates impacting data processing systems to one or more data processing systems in a staggered manner from a data source. By doing so, the likelihood of updating operation of the impacted data processing systems using the data to complete policy updates to facilitate continued provisioning of desired computer implemented services (e.g., by the data processing systems) may be increased. Consequently, a resource cost (e.g., computational resources, time resources, cognitive resources) of providing unsuccessful policy updates may be reduced.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, an interaction diagram in accordance with an embodiment is shown in FIG. 2B. This interaction diagram may illustrate how data may be obtained and used within the system of FIG. 1.

In the interaction diagram, processes performed by and interactions between components of a system in accordance with an embodiment are shown. In the diagram, components of the system are illustrated using a first set of shapes (e.g., 100A, 102, 104A, etc.), located towards the top of each figure. Lines descend from these shapes. Processes performed by the components of the system are illustrated using a second set of shapes (e.g., 228, 234, etc.) superimposed over these lines. Interactions (e.g., communication, data transmissions, etc.) between the components of the system are illustrated using a third set of shapes (e.g., 220, 230, 238, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 224 may occur prior to the interaction labeled as 226. However, it will be appreciated that the processes and interactions may be performed in different orders, any may be omitted, and other processes or interactions may be performed without departing from embodiments disclosed herein.

Turning to FIG. 2B, a first interaction diagram in accordance with an embodiment is shown. The first interaction diagram may illustrate processes and interactions that may occur during implementation of staggering data transfers for various data processing systems.

To implement staggered data transfers, at interaction 220, a dynamic transfer window (DTW) and a policy update may be provided to data processing system 100C by management system 102. For example, the dynamic transfer window and the policy update may be generated and provided to data processing system 100C via (i) transmission via a message, (ii) storing in a storage with subsequent retrieval by data processing system 100C, (iii) via a publish-subscribe system where data processing system 100C subscribes to updates from management system 102 thereby causing a copy of the dynamic transfer window and the policy update to be propagated to data processing system 100C, and/or via other processes. By providing the dynamic transfer window and the policy update to data processing system 100C, data processing system 100C may provide policy management services.

The dynamic transfer window and the policy update may specify a change in operation of the respective data processing system which may require the use of data stored and/or otherwise managed by a remote data source (e.g., remotely located from the respective data processing system). For example, the policy update provided by management system 102 may include an issuance of a policy update to a portion of data processing systems (e.g., data processing systems 100A-100C) and include information identifying data source 104A as the data source to provide the data necessary to perform the policy update.

The data source may lack sufficient capacity to provide copies of the data to each data processing system at the same point in time. For example, data source 104A may include limited bandwidth for transferring data to data processing systems 100A-100C at the same point in time, and as such, may result in limited performance of the data source 104A (e.g., reduce transfer of data, failed transfer of data, etc.). As such, a dynamic transfer window may be provided to each respective data processing system to distribute load on the data source (e.g., data source 104A) across a period of time. The dynamic transfer window may define a period of time in which the respective data processing system may obtain the data from the data source. Each data processing system may utilize a distribution function adapted to select a point in time for the respective data processing system to attempt to obtain the data from data source 104A. For example, data source 104A may have sufficient capacity to provide the copies of the data to each respective data processing system during the period of time defined by the dynamic transfer window.

Similarly to interaction 220, at interaction 224, the dynamic transfer window and the policy update may be provided to data processing system 100B by management system 102. For example, the dynamic transfer window and the policy update may be generated and provided to data processing system 100B via (i) transmission via a message, (ii) storing in a storage with subsequent retrieval by data processing system 100B, (iii) via a publish-subscribe system where data processing system 100B subscribes to updates from management system 102 thereby causing a copy of the dynamic transfer window and the policy update to be propagated to data processing system 100B, and/or via other processes. By providing the dynamic transfer window and the policy update to data processing system 100B, data processing system 100B may provide policy management services.

At interaction 226, the dynamic transfer window and the policy update may be provided to data processing system 100A by management system 102. For example, the dynamic transfer window and the policy update may be generated and provided to data processing system 100A via (i) transmission via a message, (ii) storing in a storage with subsequent retrieval by data processing system 100A, (iii) via a publish-subscribe system where data processing system 100A subscribes to updates from management system 102 thereby causing a copy of the dynamic transfer window and the policy update to be propagated to data processing system 100A, and/or via other processes. By providing the dynamic transfer window and the policy update to data processing system 100A, data processing system 100A may provide policy management services.

Following interaction 226, policy management process 228 may be initiated. During policy management process 228, a policy update process may be initiated by the data processing system (e.g., more specifically a management agent hosted by data processing system 100A). Initiating the policy update process may include: (i) identifying a data source that has data usable to perform the policy update, (ii) identifying a point in time to attempt to obtain the data from the data source, (iii) attempting to obtain the data from the data source at the identified point in time, (iv) receive a response from the data source, and/or (v) any other processes to facilitate the policy update process of the data processing system.

As described above, the dynamic transfer window and the policy update may be used by the respective data processing system to identify the data source that has the data for performing the policy update and a period of time in which a point in time may be selected (e.g., randomly by the distribution function hosted by the respective data processing system) to attempt to obtain the data from the data source. For example, data processing system 100A may use the policy update to identify data source 104A has data usable to perform the policy update, and select a point in time (e.g., at a first point in time) to attempt to obtain the data from data source 104A.

For example, at interaction 230, a request may be provided to data source 104A by data processing system 100A. For example, the request may be generated and provided to data source 104A via (i) transmission via a message, (ii) storing in a storage with subsequent retrieval by data source 104A, (iii) via a publish-subscribe system where data source 104A subscribes to updates from data processing system 100A thereby causing a copy of the request to be propagated to data source 104A, and/or via other processes. By providing the request to data source 104A, data source 104A may receive the request for the data and as a result, may manage the request for the data from data processing system 100A.

At interaction 232, a response may be provided to data processing system 100A by data source 104A. For example, the response may be generated and provided to data processing system 100A via (i) transmission via a message, (ii) storing in a storage with subsequent retrieval by data processing system 100A, (iii) via a publish-subscribe system where data processing system 100A subscribes to updates from data source 104A thereby causing a copy of the request to be propagated to data processing system 100A, and/or via other processes. By providing the response to data processing system 100A, data processing system 100A may receive the response to the request for the data and as a result, data processing system 100A may perform policy management services.

The policy management process as described above may be performed in a similar manner by the other data processing systems of the portion of data processing systems (e.g., data processing systems 100B and 100C) that received the policy update from management system 102. For example, data processing system 100B may use the policy update to identify data source 104A has data usable to perform the policy update, and select a point in time (e.g., a second point in time) to attempt to obtain the data from data source 104A.

For example, at interaction 236, a request may be provided to data source 104A by data processing system 100B. For example, the request may be generated and provided to data source 104A via (i) transmission via a message, (ii) storing in a storage with subsequent retrieval by data source 104A, (iii) via a publish-subscribe system where data source 104A subscribes to updates from data processing system 100B thereby causing a copy of the request to be propagated to data source 104A, and/or via other processes. By providing the request to data source 104A, data source 104A may receive the request for the data and as a result, may manage the request for the data from data processing system 100B.

Similar to interaction 236, at interaction 242, a request may be provided to data source 104A by data processing system 100C. The request may be generated and provided in a similar manner as described in interaction 236.

At interaction 238, a response may be provided to data processing system 100B by data source 104A. For example, the response may be generated and provided to data processing system 100B via (i) transmission via a message, (ii) storing in a storage with subsequent retrieval by data processing system 100B, (iii) via a publish-subscribe system where data processing system 100B subscribes to updates from data source 104A thereby causing a copy of the request to be propagated to data processing system 100B, and/or via other processes. By providing the response to data processing system 100B, data processing system 100B may receive the response to the request for the data and as a result, data processing system 100B may perform policy management services.

Similar to interaction 238, at interaction 244, a response may be provided to data processing system 100C by data source 104A. The response may be provided in a similar manner as described in interaction 238.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2B may perform various methods for managing operation of a data processing system. FIG. 3 illustrate a method that may be performed by the components of the system of FIGS. 1-2B. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the system of FIG. 1, and/or any other entity without departing from embodiments disclosed herein.

At operation 300, a policy update and a window definition may be obtained by a data processing system of the data processing systems. The policy update and the window definition may be obtained by: (i) generating a data structure indicating that a policy update may be performed for a portion of data processing systems, (ii) providing the data structure to the portion of data processing systems (e.g., for which the policy update is to be performed), (iii) storing the data structure in a database and/or other storage architecture for retrieval by an entity responsible for obtaining the policy update and the window definition, and/or (iv) other methods.

At operation 302, a data source that has data usable to perform the policy update may be identified by the data processing system. Identifying the data source that had data usable to perform the policy update may include: (i) reading the data source from storage, (ii) receiving the identity of the data source from another entity, and/or (iii) performing other methods.

At operation 304, a point in time to attempt to obtain the data from the data source may be identified by the data processing system. The point in time may be based on the window definition and a distribution function used by all of the data processing systems to distribute load on the data source and from the data processing systems across time. For example, identifying the point in time to attempt to obtain the data from the data source may include using a distributed function used by all of the data processing systems to randomly select the point in time from any points in time during the window definition.

At operation 306, an attempt to obtain the data from the data source and at the point in time may be made by the data processing system. Attempting to obtain the data from the data source at the point in time may include: (i) obtaining a request for the data (e.g., via generation), (ii) providing the request of the data from the data processing system to the data source(e.g., via a message over a communication system), and/or (iii) other methods.

At operation 308, a determination may be made whether the attempt to obtain the data from the data source at the point in time is successful. Determining whether the attempt to obtain the data from the data source at the point in time is successful may include: (i) reading a result of the attempting to obtain the data for the policy update from the data source, (ii) receiving a notification from another entity indicating whether the data is able to be obtained from the data source, (iii) receiving a response from the data source including the data usable to perform the policy update, and/or (iv) other methods.

If it is determined that the attempt to obtain the data from the data source at the point in time is successful (e.g., the determination is “Yes” at operation 308), then the method may proceed to operation 310.

At operation 310, operation of the data processing system may be updated using the data to complete the policy update to facilitate continued provisioning of the computer implemented services. For example, operation of the data processing system may be updated by receiving the data from the data source and storing data in a storage architecture hosted by the data processing system. The method may end following operation 310.

Returning to operation 308, if it is determined that the attempt to obtain the data from the data source at the point in time is unsuccessful (e.g., the determination is “No” at operation 308), then the method may proceed to operation 312. At operation 312, a conclusion that the data was not obtained from the data source and a new point in time may be identified to attempt to obtain the data from the data source. The new point in time may be identified by using a distributed function (e.g., hosted by the data processing system) to randomly select the new point in time from any point in time during the window definition.

The method may end following operation 312.

Thus, using the methods illustrated in FIG. 3, embodiments disclosed herein may provide systems and methods usable to managing operation of a deployment of data processing systems by providing policy updates to a portion of data processing systems affected by the policy updates in a staggered manner based on, at least in part, a window definition. By providing the policy update and the window definition to the respective data processing systems, a data processing system may identify a point in time to attempt to obtain data from a data source usable to perform the policy update. By doing so, the likelihood of successfully obtaining and/or using the data (e.g., by the data processing system) to complete the policy update may be increased, thereby updating operation of the data processing system and facilitating continued provisioning of desired computer implemented services by the data processing system as part of a deployment.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment comprising data processing systems, the method comprising:
obtaining, by a data processing system of the data processing systems, a policy update and a window definition;
identifying, by the data processing system, a data source that has data usable to perform the policy update;
identifying, by the data processing system, a point in time to attempt to obtain the data from the data source, the point in time being based on the window definition and a distribution function used by all of the data processing systems to distribute load on the data source and from the data processing systems across time;
attempting, by the data processing system, to obtain the data from the data source and at the point in time; and
in a first instance of the attempting where the data is successfully obtained:
updating operation of the data processing system using the data to complete the policy update to facilitate continued provisioning of computer implemented services.

2. The method of claim 1, wherein the window definition defines a period of time in which the data processing system is to obtain the data from the data source.

3. The method of claim 2, wherein the distribution function is adapted to select the point in time within the period of time.

4. The method of claim 3, wherein the distribution function randomly selects the point in time from any points in time during the period of time, and each of the data processing systems using same distribution functions.

5. The method of claim 1, wherein the policy update specifies a change in operation of the data processing system that requires use of the data.

6. The method of claim 5, wherein the data source is remote to the data processing system, and the data source is adapted to provide copies of the data to each of the data processing systems.

7. The method of claim 6, wherein the policy update is obtained from a management system that issues the policy updates to a portion of the data processing systems, and the data source lacks sufficient capacity to provide the copies of the data to each data processing system of the portion of the data processing systems at a same point in time.

8. The method of claim 7, wherein the data source has sufficient capacity to provide the copies of the data to each data processing system of the portion of the data processing systems during a period of time defined by the window definition.

9. The method of claim 1, wherein the policy update is completed after the operation of the data processing system has been updated using the data.

10. The method of claim 9, wherein the updated operation of the data processing system reduces at least one selected from a group consisting of:
risk of compromise of the data processing system;
undesired operation of the data processing system; and
risk of loss of data hosted by the data processing system.

11. The method of claim 1, wherein the window definition is based on a capacity of the data source for providing copies of the data and a total number of the data processing systems to which the policy update is to be applied.

12. A non-transitory machine-readable medium having instructions stored therein, which when executed by a processor, cause the processor to perform operations for managing operation of a deployment comprising data processing systems, the operations comprising:
obtaining, by a data processing system of the data processing systems, a policy update and a window definition;
identifying, by the data processing system, a data source that has data usable to perform the policy update;
identifying, by the data processing system, a point in time to attempt to obtain the data from the data source, the point in time being based on the window definition and a distribution function used by all of the data processing systems to distribute load on the data source and from the data processing systems across time;
attempting, by the data processing system, to obtain the data from the data source and at the point in time; and
in a first instance of the attempting where the data is successfully obtained:
updating operation of the data processing system using the data to complete the policy update to facilitate continued provisioning of computer implemented services.

13. The non-transitory machine-readable medium of claim 12, wherein the window definition defines a period of time in which the data processing system is to obtain the data from the data source.

14. The non-transitory machine-readable medium of claim 13, wherein the distribution function is adapted to select the point in time within the period of time.

15. The non-transitory machine-readable medium of claim 14, wherein the distribution function randomly selects the point in time from any points in time during the period of time, and each of the data processing systems using same distribution functions.

16. The non-transitory machine-readable medium of claim 12, wherein the policy update specifies a change in operation of the data processing system that requires use of the data.

17. A data processing system, comprising:
a processor; and
a memory coupled to the processor to store instructions, which when executed by the processor, cause the processor to perform operations for managing operation of a deployment comprising data processing systems, the operations comprising:
obtaining, by a data processing system of the data processing systems, a policy update and a window definition;
identifying, by the data processing system, a data source that has data usable to perform the policy update;
identifying, by the data processing system, a point in time to attempt to obtain the data from the data source, the point in time being based on the window definition and a distribution function used by all of the data processing systems to distribute load on the data source and from the data processing systems across time;
attempting, by the data processing system, to obtain the data from the data source and at the point in time; and
in a first instance of the attempting where the data is successfully obtained:
updating operation of the data processing system using the data to complete the policy update to facilitate continued provisioning of computer implemented services.

18. The data processing system of claim 17, wherein the window definition defines a period of time in which the data processing system is to obtain the data from the data source.

19. The data processing system of claim 18, wherein the distribution function is adapted to select the point in time within the period of time.

20. The data processing system of claim 19, wherein the distribution function randomly selects the point in time from any points in time during the period of time, and each of the data processing systems using same distribution functions.
